(19) United States
(12) Patent Application Publication
(10) Pub. No.: US 2009/0132954 A1
(43) Pub. Date: May 21, 2009

(54) APPARATUS AND METHOD FOR ISOLATING PROBLEMS IN CONTENT LOADED INTO A HUMAN-MACHINE INTERFACE APPLICATION

(75) Inventor: David J. Cupitt, North Narrabeen (AU)

Correspondence Address: Anthony Miologos;Honeywell International Inc., 101 Columbia Road, PO BOx 2245, Morristown, NJ, 07962, US

(73) Assignee: Honeywell International Inc., Morristown, NJ (US)

(21) Appl. No.: 11/942,886

(22) Filed: Nov. 20, 2007

(51) Int. Cl. G06F 3/048; G06F 11/07

(52) U.S. Cl. 715/781; 714/2; 714/E11.021

(57) ABSTRACT

A human-machine interface (HMI) application can be separated into a framework component and one or more view components. The framework component could be responsible for generating a window with components common across multiple ones of the view components. The framework component could also select one of the view components from a pool. Content can be loaded into the selected view component and presented in a display area of the window using the selected view component. The framework component can also detect a problem associated with the content presented to the user and/or the selected view component, such as an execution error. In addition, the framework component may take corrective action to resolve the problem, such as by reloading the selected view component (which could be done automatically). In this way, errors associated with the selected view component may not cause termination of or other difficulties with the framework component.

### TECHNICAL FIELD

This disclosure relates generally to process control systems and more specifically to an apparatus and method for isolating problems in content loaded into a human-machine interface (HMI) application.

### BACKGROUND

Processing facilities are often managed using process control systems. Example processing facilities include manufacturing plants, chemical plants, crude oil refineries, and ore processing plants. Among other operations, process control systems typically manage the use of motors, valves, and other industrial equipment in the processing facilities.

In conventional process control systems, human-machine interface (HMI) applications are used to generate graphical displays, which provide content associated with processes being monitored. The HMI applications ideally provide human operators with a continuous view of the processes being monitored. This may allow, for example, the human operators to ensure proper operation of the processes and to identify and resolve any problems that arise.

In general, interruptions in the execution of an HMI application may cause a loss of operator view over a process. This is often undesirable since it prevents the human operator from successfully monitoring and/or controlling the process. However, open-system process control HMI applications often allow content from various providers to be loaded into the HMI applications. Also, the provider of an HMI application often cannot control (or verify the safety or quality of) content loaded into the HMI application. As a result, content loaded into an HMI application could interfere with the operation of the HMI application, which may interfere with and cause a loss of view over a process being monitored.

### SUMMARY

This disclosure provides an apparatus and method for isolating problems in content loaded into a human-machine interface (HMI) application.

In a first embodiment, a method includes selecting one of multiple view components from a pool, loading content into the selected view component, and presenting the content to a user using the selected view component. The method also includes detecting a problem associated with the content presented to the user and/or the selected view component. The method further includes taking corrective action to resolve the problem.

In particular embodiments, presenting the content to the user includes presenting a window to the user, where the window includes components that are common across multiple ones of the view components. Presenting the content to the user also includes presenting the content in a display area within the window. The content presented in the display area may not appear to reside in a separate window.

In other particular embodiments, prior content has been presented to the user in a display area of a window using a prior selected view component. Also, presenting the content to the user includes removing the prior content from the display area and presenting the content to the user in the display area. The method may further include unloading the prior content from the prior selected view component and returning the prior selected view component to the pool.

In yet other particular embodiments, detecting the problem includes detecting at least one execution error associated with the selected view component. Also, taking the corrective action includes reloading the selected view component. The selected view component could represent a web page, and reloading the selected view component could include reloading the web page. The selected view component could be reloaded automatically without requiring user action.

In still other particular embodiments, the content presented to the user includes information and one or more controls associated with a process control system.

In a second embodiment, an apparatus includes at least one memory configured to store a view component, where the view component is associated with a graphical presentation. The apparatus also includes at least one processor configured to load content into the view component and to present the content to a user using the view component. The at least one processor is also configured to detect a problem associated with the content presented to the user and/or the view component. The at least one processor is further configured to take corrective action to resolve the problem.

In particular embodiments, the at least one memory is configured to store multiple view components in a pool. Also, the at least one processor is configured to select one of the view components from the pool, where the selected view component is used to present the content to the user and is later returned to the pool for reuse.

In a third embodiment, a computer program is embodied on a computer readable medium. The computer program includes computer readable program code for presenting a window to a user, where the window includes components that are common across multiple view components. The computer program also includes computer readable program code for selecting a first of the multiple view components, for loading first content into the first selected view component, and for presenting the first content to the user in a display area of the window using the first selected view component. The computer program further includes computer readable program code for selecting a second of the multiple view components, for loading second content into the second selected view component, and for presenting the second content to the user in the display area of the window using the second selected view component.

In particular embodiments, the computer program also includes computer readable program code for detecting a problem associated with the second content and/or the second selected view component and computer readable program code for reloading the second selected view component to resolve the problem.

In other particular embodiments, the multiple view components form a pool, and the computer program includes computer readable program code for periodically terminating and restarting non-selected view components in the pool.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example process control system according to this disclosure;

FIG. 2 illustrates an example human-machine interface (HMI) application for isolating problems in content loaded into the HMI application according to this disclosure;

FIG. 3 illustrates an example graphical display for isolating problems in content loaded into an HMI application according to this disclosure; and

FIG. 4 illustrates an example method for isolating problems in content loaded into an HMI application according to this disclosure.

### DETAILED DESCRIPTION

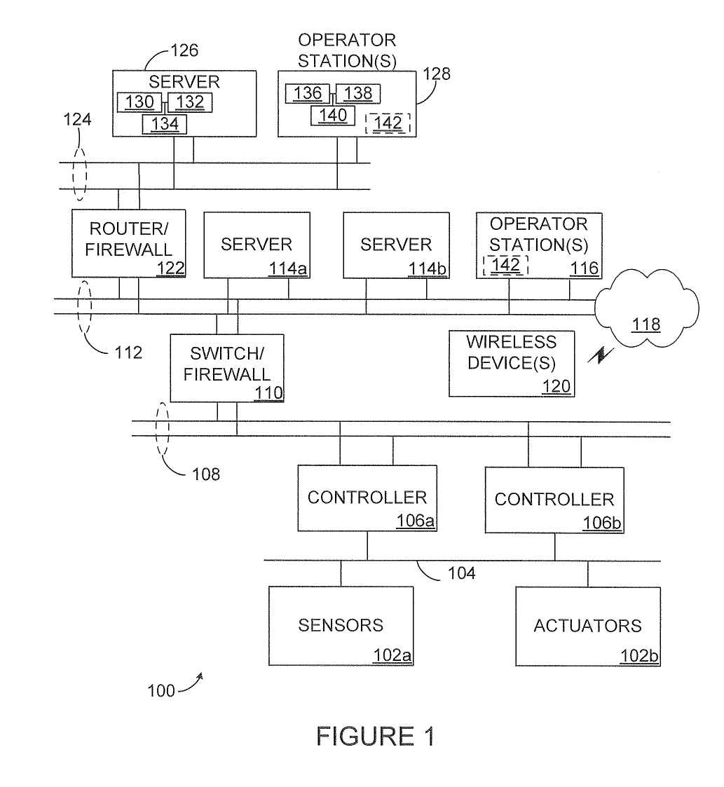

FIGS. 1 through 4, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates an example process control system 100 according to this disclosure. The embodiment of the process control system 100 shown in FIG. 1 is for illustration only. Other embodiments of the process control system 100 may be used without departing from the scope of this disclosure.

In this example embodiment, the process control system 100 includes various components that facilitate production or processing of at least one product or other material, such as one or more sensors 102a and one or more actuators 102b. The sensors 102a and actuators 102b represent components in a process system that may perform any of a wide variety of functions. For example, the sensors 102a could measure a wide variety of characteristics in the process system, such as temperature, pressure, or flow rate. Also, the actuators 102b could alter a wide variety of characteristics in the process system, such as heaters, motors, catalytic crackers, or valves. The sensors 102a and actuators 102b could represent any other or additional components in any suitable process system. Each of the sensors 102a includes any suitable structure for measuring one or more characteristics in a process system. Each of the actuators 102b includes any suitable structure for operating on or affecting conditions in a process system. Also, a process system may generally represent any system or portion thereof configured to process one or more products or other materials in some manner.

At least one network 104 is coupled to the sensors 102a and actuators 102b. The network 104 facilitates interaction with the sensors 102a and actuators 102b. For example, the network 104 could transport measurement data from the sensors 102a and provide control signals to the actuators 102b. The network 104 could represent any suitable network or combination of networks. As particular examples, the network 104 could represent an Ethernet network, an electrical signal network (such as a HART or FOUNDATION FIELDBUS network), a pneumatic control signal network, or any other or additional type(s) of network(s).

Two controllers 106a-106b are coupled to the network 104. The controllers 106a-106b may, among other things, use the measurements from the sensors 102a to control the operation of the actuators 102b. For example, the controllers 106a-106b could receive measurement data from the sensors 102a and use the measurement data to generate control signals for the actuators 102b. Each of the controllers 106a-106b includes any hardware, software, firmware, or combination thereof for interacting with the sensors 102a and controlling the actuators 102b. The controllers 106a-106b could, for example, represent multivariable controllers or other types of controllers. As a particular example, each of the controllers 106a-106b could represent a computing device running a MICROSOFT WINDOWS operating system.

Two networks 108 are coupled to the controllers 106a-106b. The networks 108 facilitate interaction with the controllers 106a-106b, such as by transporting data to and from the controllers 106a-106b. The networks 108 could represent any suitable networks or combination of networks. As particular examples, the networks 108 could represent a pair of Ethernet networks or a redundant pair of Ethernet networks, such as a FAULT TOLERANT ETHERNET (FTE) network from HONEYWELL INTERNATIONAL INC.

At least one switch/firewall 110 couples the networks 108 to two networks 112. The switch/firewall 110 may transport traffic from one network to another. The switch/firewall 110 may also block traffic on one network from reaching another network. The switch/firewall 110 includes any suitable structure for providing communication between networks, such as a HONEYWELL CONTROL FIREWALL (CF9) device. The networks 112 could represent any suitable networks, such as a pair of Ethernet networks or an FTE network.

Two servers 114a-114b are coupled to the networks 112. The servers 114a-114b perform various functions to support the operation and control of the controllers 106a-106b, sensors 102a, and actuators 102b. For example, the servers 114a-114b could log information collected or generated by the controllers 106a-106b, such as measurement data from the sensors 102a or control signals for the actuators 102b. The servers 114a-114b could also execute applications that control the operation of the controllers 106a-106b, thereby controlling the operation of the actuators 102b. In addition, the servers 114a-114b could provide secure access to the controllers 106a-106b. Each of the servers 114a-114b includes any hardware, software, firmware, or combination thereof for providing access to, control of, or operations related to the controllers 106a-106b. Each of the servers 114a-114b could, for example, represent a computing device running a MICROSOFT WINDOWS operating system.

One or more operator stations 116 are coupled to the networks 112. The operator stations 116 represent computing or communication devices providing user access to the servers 114a-114b, which could then provide user access to the controllers 106a-106b (and possibly the sensors 102a and actuators 102b). As particular examples, the operator stations 116 could allow users to review the operational history of the sensors 102a and actuators 102b using information collected by the controllers 106a-106b and/or the servers 114a-114b. The operator stations 116 could also allow the users to adjust the operation of the sensors 102a, actuators 102b, controllers 106a-106b, or servers 114a-114b. In addition, the operator stations 116 could receive and display warnings, alerts, or other messages or displays generated by the controllers 106a-106b or the servers 114a-114b. Each of the operator stations 116 includes any hardware, software, firmware, or combination thereof for supporting user access and control of the system 100. Each of the operator stations 116 could, for example, represent a computing device running a MICROSOFT WINDOWS operating system.

In this example, the system 100 also includes a wireless network 118, which can be used to facilitate communication with one or more wireless devices 120. The wireless network 118 may use any suitable technology to communicate, such as radio frequency (RF) signals. Also, the wireless devices 120 could represent devices that perform any suitable functions. The wireless devices 120 could, for example, represent wireless sensors, wireless actuators, and remote or portable operator stations or other user devices.

At least one router/firewall 122 couples the networks 112 to two networks 124. The router/firewall 122 includes any suitable structure for providing communication between networks, such as a secure router or combination router/firewall. The networks 124 could represent any suitable networks, such as a pair of Ethernet networks or an FTE network.

In this example, the system 100 includes at least one additional server 126 coupled to the networks 124. The server 126 executes various applications to control the overall operation of the system 100. For example, the system 100 could be used in a processing plant or other facility, and the server 126 could execute applications used to control the plant or other facility. As particular examples, the server 126 could execute applications such as enterprise resource planning (ERP), manufacturing execution system (MES), or any other or additional plant or process control applications. The server 126 includes any hardware, software, firmware, or combination thereof for controlling the overall operation of the system 100.

One or more operator stations 128 are coupled to the networks 124. The operator stations 128 represent computing or communication devices providing, for example, user access to the servers 114a-114b, 126. Each of the operator stations 128 includes any hardware, software, firmware, or combination thereof for supporting user access and control of the system 100. Each of the operator stations 128 could, for example, represent a computing device running a MICROSOFT WINDOWS operating system.

In particular embodiments, the various servers and operator stations may represent computing devices. For example, each of the servers 114a-114b, 126 could include one or more processors 130 and one or more memories 132 for storing instructions and data used, generated, or collected by the processor(s) 130. Each of the servers 114a-114b, 126 could also include at least one network interface 134, such as one or more Ethernet interfaces. Also, each of the operator stations 116, 128 could include one or more processors 136 and one or more memories 138 for storing instructions and data used, generated, or collected by the processor(s) 136. Each of the operator stations 116, 128 could also include at least one network interface 140, such as one or more Ethernet interfaces.

In one aspect of operation, at least one of the operator stations 116, 128 includes a human-machine interface (HMI) application 142. An HMI application 142 generates graphical displays that present content visually representing one or more processes (or portions thereof) being monitored and/or controlled. Each HMI application 142 includes any suitable hardware, software, firmware, or combination thereof for generating graphical displays representing at least part of a process being monitored and/or controlled. As a particular example, the HMI application 142 could use HMIWEB technology from HONEYWELL INTERNATIONAL INC. The HMIWEB technology uses hypertext markup language (HTML) and allows users to build process control displays (web pages) that are loaded onto operator stations 116, 128. The HTML displays may use INTERNET EXPLORER or other browser technology to extend the functionality of the web pages to allow process information to be displayed and to allow operators to control processes via the web pages.

In some embodiments, the HMI application 142 is provided by a first party and used by a second party. Also, one or more third parties may provide content (such as web pages having process controls) that can be loaded into the HMI application 142. The first party typically has little or no control over, and cannot verify the safety or quality of, the content provided by the third parties. Moreover, the content provided by third parties may suffer from various problems, such as rogue controls or execution errors. Execution errors may include memory leaks, application faults, and memory corruption errors (among others). In conventional systems, these errors can actually affect the HMI application 142, such as by causing the HMI application 142 to terminate, which interrupts an operator's view of a process being monitored.

In accordance with this disclosure, an HMI application 142 is separated into multiple components, namely a framework component and one or more view components. The framework component generally includes generic features required to generate a graphical display. For example, in a MICROSOFT WINDOWS operating system, the framework component could include the functions for generating or supporting menus, toolbars, and management buttons (such as close, minimize, and maximize) located on the title bar of a window. The framework component could also include application-specific global functions, such as initiating and maintaining a connection to a server and maintaining operator credentials for security. Each view component generally includes the functions for loading specific HMI content into a window. For instance, a view component could display data representing process variables for a specific process, which provide a view into that specific process. The view component could also provide controls for interacting with and controlling those process variables. A framework component includes any hardware, software, firmware, or combination thereof for generating more generic or common aspects of a graphical display. A view component includes any hardware, software, firmware, or combination thereof for generating more specific or customized aspects of a graphical display.

The framework component of the HMI application 142 can be separated from the one or more view components of the HMI application 142 in any suitable manner. For example, the framework and view components could be separated into different executable files or modules, and the framework executable file or module could be responsible for invoking the appropriate view executable file or module. By separating the framework and view components, any problems arising from the content displayed using a view component or from the operation of the view component can be constrained to that view component. In other words, these problems may not affect an operator's connection to or view over a process. For instance, in the event that an execution error or other problem occurs with a view component, the framework component can detect this problem and re-initiate execution of the same or another view component, such as by reloading a web page associated with the view component. In this way, the framework component can seamlessly restore an operator's view of a process without requiring any action by the operator.

Moreover, the separation of the framework and view components may be done in a manner that is not very evident to an operator. For example, the HMI application 142 may appear no different than a single window application, or an application that uses a single window to present information to a user (such as a Single Document Interface or “SDI” application). As a particular example, when using the HMI application 142, the operator may see a single window having a menu, a toolbar, and management buttons on a title bar (provided by the framework component), as well as process control-related content (provided by the view component). The operator may be unaware that two different components are generating a graphical display for the operator.

By dividing the HMI application 142 into multiple components in this manner, various execution errors and other problems can be constrained in the system 100. For example, if a view component leaks memory such that it threatens to exhaust or actually exhausts the available resources on an operator station or other device, the view component can be terminated, and a new view component can be created/executed to replace it without requiring a restart of the framework component. As another example, if a view component experiences an application fault that causes the view component to terminate, this fault can be constrained to the view component and does not extend to the framework component. The framework component can detect this condition and restore the view component, thus reducing or minimizing the interruption of the operator's view. As a third example, errors that a view component may make in accessing memory may only affect the currently-loaded view component and not necessarily the framework component. It should be noted that an application fault may occur at an unspecified time after a memory corruption error has occurred (when the affected memory is eventually accessed). To guard against this type of issue, view components can be periodically terminated and restarted while in a view component “pool” (which is described below).

Using these techniques, it is possible to significantly reduce or even eliminate the impact of certain errors and other problems on an operator's view of a process being monitored. Errors and other problems in a view component can be detected by the framework component, and appropriate steps can be taken by the framework component, such as by reloading a web page associated with a view component. This may help to maintain the operator's view of a process and may require little or no operator input.

Although FIG. 1 illustrates one example of a process control system 100, various changes may be made to FIG. 1. For example, a control system could include any number of sensors, actuators, controllers, servers, operator stations, networks, wireless networks, and wireless devices. Also, the makeup and arrangement of the process control system 100 in FIG. 1 is for illustration only. Components could be added, omitted, combined, or placed in any other suitable configuration according to particular needs. In addition, FIG. 1 illustrates one operational environment in which an HMI application can be divided into multiple components. This functionality could be used in any other suitable device or system.

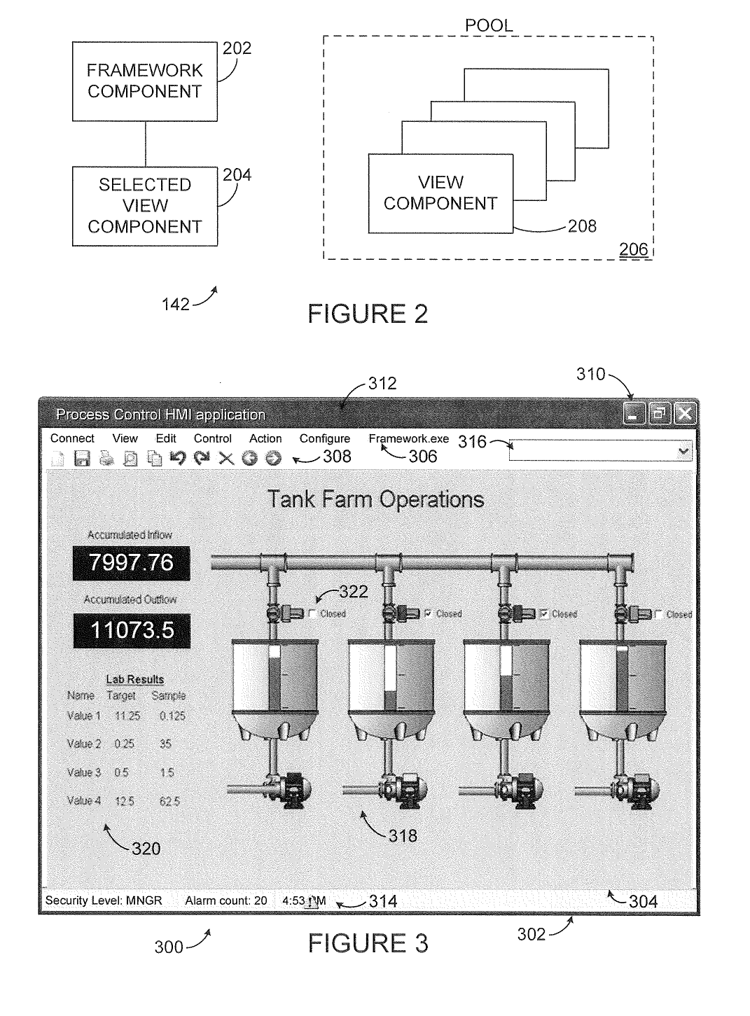

FIG. 2 illustrates an example human-machine interface (HMI) application 142 for isolating problems in content loaded into the HMI application according to this disclosure. The embodiment of the HMI application 142 shown in FIG. 2 is for illustration only. Other embodiments of the HMI application 142 could be used without departing from the scope of this disclosure. Also, for ease of explanation, the HMI application 142 of FIG. 2 is described with respect to an operator station in the process control system 100 of FIG. 1. The HMI application 142 could be used in any other suitable device or system.

As shown in FIG. 2, the HMI application 142 includes a framework component 202. The framework component 202 supports the generic features used to generate graphical displays. This could include features for creating menus, toolbars, and management buttons, as well as features for performing application-specific global functions and for displaying alarm, status, and other generic information. The framework component 202 also selects a particular view component 204, which can be used to load specific HMI content and controls into a window. In other words, the framework component 202 is used to generate generic portions of a graphical display (which may be common across multiple graphical displays), and the selected view component 204 is used to customize the graphical display.

In this example, the selected view component 204 is chosen from a pool 206, which contains multiple view components 208 (including the selected view component 204). The framework component 202 may operate to make the selected view component 204 visible to an operator, while the other view components 208 in the pool 206 may be non-visible to or hidden from the operator. The non-selected view components 208 could represent any suitable components, such as components that can be maintained and that are ready for use as the operator navigates within a graphical user interface.

The framework component 202 may choose the selected view component 204 for presentation to the operator in any suitable manner. For example, the framework component 202 could use input from the operator, where the input defines where the operator is navigating within a graphical user interface. Based on this or any other suitable information, the framework component 202 may select one of the view components 208 in the pool 206 as the selected view component 204. The framework component 202 may then load the selected view component 204 into the HMI application 142.

In some embodiments, the framework component 202 could perform additional functions for view components 208. For example, the framework component 202 may be responsible for the lifetime management of the view components 208 in the pool 206. This could include the framework component 202 creating executable files representing the view components 208 (such as at a startup time) and destroying the executable files (such as at a shut down time). The framework component 202 may also coordinate the loading and unloading of content into each of the selected view components 204 as the operator navigates across a process display. The framework component 202 may further monitor the responsiveness, resource usage, and age of each view component 208 and take suitable action in response to certain events (such as periodically terminating and restarting non-selected view components 208 in the pool 206). In addition, the framework component 202 may terminate and create replacement view components (such as replacement executables) if and when a selected view component 204 experiences problems. Example problems may occur when the selected view component 204 experiences an application error, stops responding, starts consuming excessive resources, or exceeds a maximum number of display call-ups (where each view component could be viewed a specified number of times in a given period).

Although FIG. 2 illustrates one example of an HMI application 142 for isolating problems in content loaded into the HMI application, various changes may be made to FIG. 2. For example, an operator station or other device could include any suitable number of framework components 202, selected view components 204, pools 206, and view components 208. Also, while shown as supporting a single selected view component 204 at any given time, a framework component 202 could support the use of any number of selected view components 204 at the same time.

FIG. 3 illustrates an example graphical display 300 for isolating problems in content loaded into an HMI application according to this disclosure. The embodiment of the graphical display 300 shown in FIG. 3 is for illustration only. Other embodiments of the graphical display 300 could be used without departing from the scope of this disclosure. Also, for ease of explanation, the graphical display 300 of FIG. 3 is described with respect to the HMI application 142 of FIG. 2 executing on an operator station in the process control system 100 of FIG. 1. The graphical display 300 could be used with any other suitable application, device, or system.

As shown in FIG. 3, the graphical display 300 includes a window 302, which includes a display area 304. The window 302 may be associated with and controlled by the framework component 202 in the HMI application 142. For example, the framework component 202 could be responsible for generating or presenting the window 302 itself, a menu 306, a toolbar 308, management buttons 310 in a title bar 312, and user/alarm/status information 314. The framework component 202 could also present a drop-down menu 316, which could be used to navigate to different displays in a graphical user interface (it may be noted that the toolbar 308 could also contain buttons used for navigation).

The selected view component 204 could be responsible for generating or presenting the actual contents of the display area 304. In this example, the selected view component 204 provides a graphical representation 318 of equipment implementing at least part of a process being monitored. The selected view component 204 also provides process information 320 related to the operation of the equipment. Further, the selected view component 204 provides controls 322 (in this example, checkboxes) that can be used to control one or more aspects of the process being monitored. Different view components 208 can be selected from the pool 206 by the framework component 202 to present different process control information within the display area 304 of the graphical display 300.

As noted above, the selected view component 204 loads content into the display area 304 to allow an operator to view and have control over a process. However, the selected view component 204 could suffer from various problems, such as memory leaks, application faults, memory corruption errors, rogue controls, or other types of problems. To reduce or avoid a loss of view over a process being monitored, the framework component 202 may detect when problems occur with the selected view component 204 and take suitable action, such as reloading the selected view component 204 or selecting a different view component 204. The operator may not be required to take any action in order to restore view over the process being monitored.

To make the selected view component 204 seamlessly appear to be part of the HMI application window (the main window 302), the selected view component 204 can have its title bar and window frame components hidden, such as by setting the WS_CHILD style on its window frame. The selected view component 204 can also be set as a child of the framework component 202, such as by using the SetParent( ) WINDOWS API call. In this way, the contents of the selected view component 204 appear within the display area 304 as if they were an integral part of the window 302. The user may be completely unaware that the contents of the display area 304 are actually from a separate component in the HMI application 142.

Although FIG. 3 illustrates one example of a graphical display 300 for isolating problems in content loaded into an HMI application, various changes may be made to FIG. 3. For example, the content and arrangement of the graphical display 300 are for illustration only. Other graphical displays containing any suitable information in any suitable layout or format could also be used.

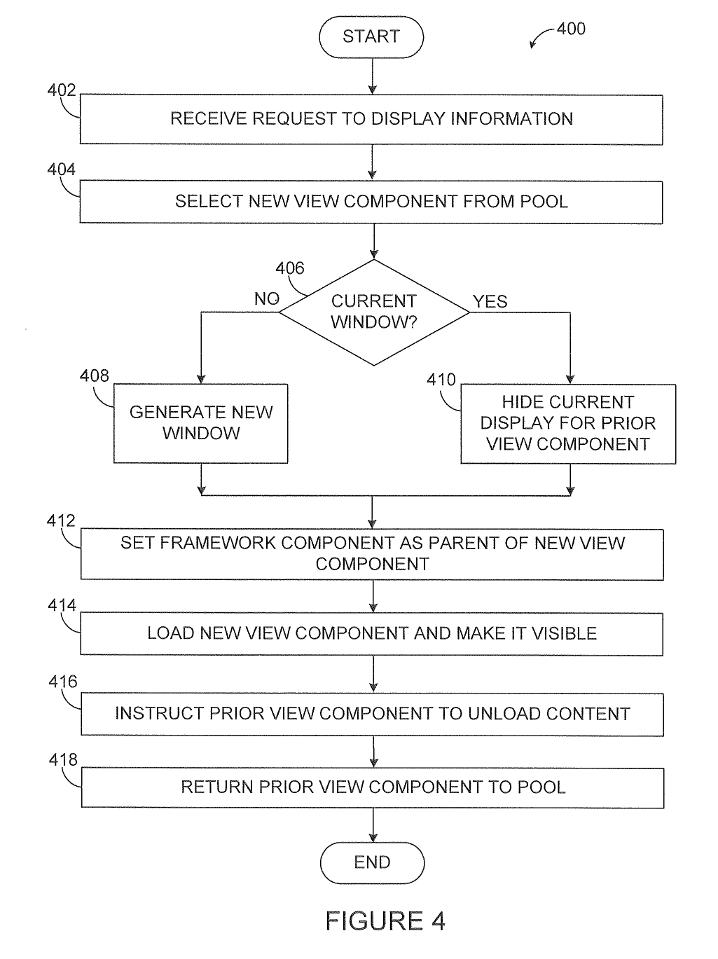

FIG. 4 illustrates an example method 400 for isolating problems in content loaded into an HMI application according to this disclosure. The embodiment of the method 400 shown in FIG. 4 is for illustration only. Other embodiments of the method 400 could be used without departing from the scope of this disclosure. Also, for ease of explanation, the method 400 of FIG. 4 is described with respect to the HMI application 142 of FIG. 2 executing on an operator station in the process control system 100 of FIG. 1. The method 400 could be used with any suitable application, device, or system.

A request to display information is received at step 402. This could include, for example, the HMI application 142 receiving input from an operator. The input could represent any suitable information, such as an identification of a process to be monitored. The input could also be received in any suitable manner, such as via a keyboard, mouse, or other input device.

A new view component is selected from a pool of view components at step 404. This could include, for example, the framework component 202 in the HMI application 142 selecting one of the view components 208 in the pool 206 as the new selected view component 204. The framework component 202 could choose the new selected view component 204 in any suitable manner, such as by using the input receiving in step 402. The new selected view component 204 could, for example, be associated with a process that the operator wishes to monitor and/or control.

A determination is made whether a current window is displaying information for a prior selected view component at step 406. This could include, for example, the framework component 202 in the HMI application 142 determining whether any window 302 is currently being used to present content loaded using a prior selected view component 204. If not, a new window is generated at step 408. This could include, for example, the framework component 202 generating a new window 302 with the appropriate menu 306, toolbar 308, management buttons 310, title bar 312, user/alarm/status information 314, and drop-down menu 316. Otherwise, if a window 302 is already being displayed, the contents of the display associated with the prior selected view component are hidden at step 410. This could include, for example, the framework component 202 clearing the display area 304 in the window 302.

The framework component is set as the parent of the new selected view component at step 412. This may include, for example, making the appropriate WINDOWS API function call. The new selected view component is loaded and made visible at step 414. This may include, for example, the framework component 202 causing the new selected view component 204 to load the appropriate content. This may also include the framework component 202 causing the content in the new selected view component 204 to be displayed in the display area 304 of the window 302. This may further include the framework component 202 hiding the title bar and window frame components of the new selected view component 204. In this way, the new selected view component 204 appears to be an integral part of the window 302, rather than a separate window overlying the window 302. At this point, an operator is free to take any suitable action using the new selected view component 204, such as reviewing process information presented and operating controls in the new selected view component 204.

The prior selected view component is instructed to unload its content at step 416 and is returned to the pool at step 418. This may include, for example, the framework component 202 clearing the content from the prior selected view component and preparing the prior selected view component for future use.

Although FIG. 4 illustrates one example of a method 400 for isolating problems in content loaded into an HMI application, various changes may be made to FIG. 4. For example, while shown as a series of steps, various steps in FIG. 4 could overlap, occur in parallel, occur in a different order, or occur multiple times.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases used throughout this patent document. The term “couple” and its derivatives refer to any direct or indirect communication between two or more elements, whether or not those elements are in physical contact with one another. The terms “application” and “program” refer to one or more computer programs, software components, sets of instructions, procedures, functions, objects, classes, instances, related data, or a portion thereof adapted for implementation in a suitable computer code (including source code, object code, or executable code). The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The term “controller” means any device, system, or part thereof that controls at least one operation. A controller may be implemented in hardware, firmware, software, or some combination of at least two of the same. The functionality associated with any particular controller may be centralized or distributed, whether locally or remotely.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
selecting one of multiple view components from a pool;
loading content into the selected view component;
presenting the content to a user using the selected view component;
detecting a problem associated with at least one of: the content presented to the user and the selected view component; and
taking corrective action to resolve the problem.

2. The method of claim 1, wherein presenting the content to the user comprises:
presenting a window to the user, the window comprising components that are common across multiple ones of the view components; and
presenting the content in a display area within the window.

3. The method of claim 2, wherein the content presented in the display area does not appear to reside in a separate window.

4. The method of claim 1, wherein:
prior content has been presented to the user in a display area of a window using a prior selected view component; and
presenting the content to the user comprises removing the prior content from the display area and presenting the content to the user in the display area.

5. The method of claim 4, further comprising:
unloading the prior content from the prior selected view component; and
returning the prior selected view component to the pool.

6. The method of claim 1, wherein:
detecting the problem comprises detecting at least one execution error associated with the selected view component; and
taking the corrective action comprises reloading the selected view component.

7. The method of claim 6, wherein:
the selected view component comprises a web page; and
reloading the selected view component comprises reloading the web page.

8. The method of claim 6, wherein reloading the selected view component comprises reloading the selected view component automatically without requiring user action.

9. The method of claim 1, wherein:
a framework component selects the selected view component; and
further comprising making the framework component operate as a parent to the selected view component.

10. The method of claim 1, wherein the content presented to the user comprises information and one or more controls associated with a process control system.

11. An apparatus comprising:
at least one memory configured to store a view component, the view component associated with a graphical presentation; and
at least one processor configured to:
load content into the view component;
present the content to a user using the view component;
detect a problem associated with at least one of: the content presented to the user and the view component; and
take corrective action to resolve the problem.

12. The apparatus of claim 11, wherein the at least one processor is configured to present the content to the user by:
presenting a window to the user, the window comprising components that are common across multiple ones of the view components; and
presenting the content in a display area within the window, wherein the content presented in the display area does not appear to reside in a separate window.

13. The apparatus of claim 11, wherein:
prior content has been presented to the user in a display area of a window using a prior view component; and
the at least one processor is configured to present the content to the user by removing the prior content from the display area and presenting the content to the user in the display area.

14. The apparatus of claim 11, wherein:
the at least one processor is configured to detect the problem by detecting at least one execution error associated with the view component; and
the at least one processor is configured to take the corrective action by reloading the view component.

15. The apparatus of claim 14, wherein the at least one processor is configured to reload the view component automatically without requiring user action.

16. The apparatus of claim 11, wherein:
the at least one memory is configured to store multiple view components in a pool; and
the at least one processor is further configured to select one of the view components from the pool, wherein the selected view component is used to present the content to the user and is later returned to the pool for reuse.

17. The apparatus of claim 11, wherein the content presented to the user comprises information and one or more controls associated with a process control system.

18. A computer program embodied on a computer readable medium, the computer program comprising:
computer readable program code for presenting a window to a user, the window comprising components that are common across multiple view components;
computer readable program code for selecting a first of the multiple view components;
computer readable program code for loading first content into the first selected view component;
computer readable program code for presenting the first content to the user in a display area of the window using the first selected view component;
computer readable program code for selecting a second of the multiple view components;
computer readable program code for loading second content into the second selected view component; and
computer readable program code for presenting the second content to the user in the display area of the window using the second selected view component.

19. The computer program of claim 18, further comprising:
computer readable program code for detecting a problem associated with at least one of: the second content and the second selected view component; and
computer readable program code for reloading the second selected view component to resolve the problem.

20. The computer program of claim 19, wherein the multiple view components form a pool; and
further comprising computer readable program code for periodically terminating and restarting non-selected view components in the pool.
